(19) United States
(12) Patent Application Publication
(10) Pub. No.: US 2013/0185329 A1
(43) Pub. Date: Jul. 18, 2013

(54) DISTRIBUTED DATABASE

(71) Applicant: Maria Cruz Bartolomé Rodrigo, Madrid (ES)

(72) Inventor: Maria Cruz Bartolomé Rodrigo, Madrid (ES)

(73) Assignee: Telefonaktiebolaget L M Ericcson, Stockholm (SE)

(21) Appl. No.: 13/876,075

(22) PCT Filed: Nov. 8, 2010
(86) PCT No.: PCT/EP2010/067063

§ 371 Date: Mar. 26, 2013

Related U.S. Application Data
(60) Provisional application No. 61/386,660, filed on Sep. 27, 2010.

(51) Int. Cl. G06F 17/30

(52) U.S. Cl. CPC G06F 17/30545
USPC 707/770

(57) ABSTRACT

According to a first aspect of the present invention there is provided a method of operating a distributed database comprising a plurality of database nodes. The method comprises, at a first database node of the plurality of database nodes, receiving a request to manipulate data from a client (B1), determining if the data is stored or is intended to be stored at the first database node and, if the data is not stored or is not intended to be stored at the first database node, forwarding the request towards a second database node of the plurality of database nodes (B2) and, prior to receiving a final response from the second database node, sending an early response to the client indicating that the data manipulation has been successful (B3).

### FIELD OF THE INVENTION

This invention relates to a method of operating a distributed database and corresponding apparatus. More particularly, the invention relates to a method of operating a distributed database that minimizes the impact of the geographical separation of the database nodes.

### BACKGROUND TO THE INVENTION

A distributed database is a database in which the data is not stored at a single physical location. Instead, it is spread across a network of database nodes that are geographically dispersed and connected via communications links. However, a client of a distributed database logically considers it to be a single database, and the client does not need to know where a piece of data is physically stored. FIG. 1 illustrates schematically an example of a distributed database system providing data access to a database client. The distributed database is comprised of a number of database (DB) nodes, with each database node being comprised of an interface, distribution logic, a storage unit, and a network connection.

The interface (e.g. a northbound interface) receives requests from a client of the distributed database. Such an interface will typically make use of a data access protocol, such as the Lightweight Directory Access Protocol (LDAP).

The distribution logic provides access to the data distributed among the plurality of database nodes that make up the distributed database. Typically, the distribution logic will function in a transparent manner such that a client perceives the distributed database to be a single logical database. A database client therefore does not need to know where any particular item of data is stored, since the distribution logic of the distributed database enables this complexity to be hidden from the client. Accordingly, a database client is usually configured to route any data queries towards one of the database nodes that acts as a so-called ‘single point of access’ for that client. A database client could also be configured to contact an alternative, back-up database node, should any attempt to contact the first database node fail.

The distribution logic within a database node that receives a query can then determine whether or not it stores the data or, if the query requires that some new data be written into the database, whether or not it is intended to store the new data. If it does not store or is not intended to store the data, the distribution logic will then determine which of the other database nodes it should forward the query to. For example, the distribution logic may be able to determine exactly which of the other database nodes stores or should store the data that is the subject of the query, and will therefore ensure that the query is forwarded towards this database node. Alternatively, the distribution logic may not be able to determine exactly which of the other database nodes stores or should store the data, but may merely be able to determine which other database node it can forward the received query to in order to ensure that the query is routed towards the database node that stores or should store the data. For example, the distribution logic may be able to identify one of the other database nodes that is ‘closer’ to the database node which stores or should store that data.

The storage unit stores the data that is the responsibility of that particular database node. The portion of the data that is stored at an individual database node is referred to as the database nodes data set (DS). For example, in FIG. 1 DB Node 1 stores DS1, DB Node 2 stores DS2, DB Node 3 stores DS3, and DB Node 4 stores DS4. It is common for a distributed database solution to divide the data to be stored into a number of “partitions”, with the data falling within a particular partition being assigned to a data set stored at a particular database node. For example, a partition may comprise user data relating to a certain range of user identifiers, such as ranges of MSISDN numbers. In addition, some or all of the partitions can be replicated in one or more database nodes for security and/or availability purposes. For example, the data stored by DB Node 3 (DS3) can comprise, among other data, user data from within a first data partition that comprises MSISDN numbers from 2000000 to 3999999. The data stored by DB Node 4 (DS4) can comprise, among other data, user data from within a second data partition that comprises MSISDN numbers from 4000000 to 5999999. However, DS3 can further comprise a replicated copy of some or all of the data stored as a master copy by DB node 4 (i.e. DS4).

A database client can be, for example, an application server, a user terminal, or any other kind of apparatus that, in order to provide a certain service, is arranged to query the database to obtain and/or manipulate data related to the service and/or to the user(s) of the service.

As the entirety of the data stored by a distributed database is distributed across the system, not all of the data is held by every database node, even if a degree of replication is implemented. As such, this will often mean that a data query that is sent to a first database node will relate to data that is not stored or is not intended to be stored at that database node. The data query must therefore be forwarded to a second database node within the distributed database system that holds either the master copy or a replicated copy of that data. The database node that first receives a query from a database client (i.e. as the client's point of access to the database) is referred to as the local database node, whilst the other database nodes within the distributed database are referred to as remote database nodes. Depending on where (i.e. at which remote database node) the data is stored or is intended to be stored, the time taken to access the data will vary, due mainly to the inherent transmission delays of the network that increase as the distance between the database nodes increases. Such access latency is typically around 1 ms per 100 km.

FIG. 2 is an example signalling flow diagram of a database client accessing data stored in a remote database node of a distributed database. The steps performed are as follows:
A1. A client sends a query relating to some data to the distributed database. To do so, the client is configured with the identity/address of one of the plurality of database nodes that is to act as a point of contact for the client. In this example, the client sends the query to its local database node, DB Node 1.
A2. The distribution logic of DB Node 1 processes the query to determine whether or not it stores or is intended to store that data that is the subject of the query. In this example, DB Node 1 determines that this data is stored or is intended to be stored at a remote database node, DB Node 2, and forwards the request on to the DB Node 2.
A3. The distribution logic of DB Node 2 processes the query, determines that the data is stored or is intended to be stored in the storage unit of DB Node 2. DB Node 2 therefore attempts to complete the requested action, generates a response to the data query indicating the result, and sends the response back to DB Node 1.
A4. DB Node 1 receives the response from DB Node 2, and forwards the response on to the client.

The delay experienced by the client prior to receiving the response to the query will depend upon the distance between the database nodes, the network bandwidth and any other limitations of the connections between the database nodes. However, this delay will be longer than would be experienced if the data was stored locally, at DB Node 1.

Expanding upon this example, if each of the four database nodes is separated by around 700 km, as may be the case for a distributed user profile database provided in a telecommunications network, and assuming that a data query that can only be handled remotely will be delayed by a further 1 ms for every 100 km of separation, it will take an additional 14 ms for the client to receive a response (i.e. 7 ms for the request to travel from DB Node 1 to DB Node 2, and a further 7 ms for the response to travel from DB Node 2 to DB Node 1). Assuming that a response to a data query that can be handled locally takes an average of 7 ms, then it would take a total of 21 ms for the client to receive a response (i.e. 7 ms plus the additional 14 ms). Therefore, the data access latency, as perceived by the client, could be very poor in some cases, especially if the database spans large distances.

In addition, if there as substantially even distribution of data amongst the four database nodes making up the distributed database, and if a client accesses all of the data within the database with equal frequency, then only 25% of the data queries will be handled locally, within the database node that acts as the clients point of contact. The remaining 75% will need to be forwarded to other database nodes and will therefore be affected by the associated delays. In such circumstances, the average latency for receiving a response to a data query would be given by:

average response latency=% local traffic×local latency+% remote traffic×remote latency

Therefore, the average response latency for the distributed database system of the above example would be:

25%×7+75%×21=17.5 ms

This means that on average it takes 150% longer to obtain a response from a distributed database than from a single physical database.

The additional latency introduced through the use of a distributed database is undesirable. In particular, for some applications it will be required that this response latency is kept below a threshold, such that the distances covered by a distributed database must be limited. This is particularly true when a data query relates to request to manipulate some data (e.g. to insert, delete, and/or change data) stored in the database. In these cases, the total delay comprises not only the inherent transmission delays due to communication between database nodes, but also the delays due to the processing required to complete the data manipulation and to generate a response to the client indicating the outcome of the requested operation(s). In addition, the time taken to respond to a data query often impacts on the performance of the client, as the client must wait for the response before it can continue with any other processes.

### SUMMARY

It is an aim of the present invention to overcome, or at least mitigates, the above-mentioned problems.

According to a first aspect of the present invention there is provided a method of operating a distributed database comprising a plurality of database nodes. The method comprises:
at a first database node of the plurality of database nodes:
   receiving, from a client, a request to manipulate data;
   determining if the data is stored or is intended to be stored at the first database node; and
   if the data is not stored or is not intended to be stored at the first database node, forwarding the request towards a second database node of the plurality of database nodes and, prior to receiving a final response from the second database node, sending an early response to the client indicating that the data manipulation has been successful.

By employing this method, a client would receive responses to data manipulation requests with a latency substantially equal to that experienced for data that is stored or that is intended to be stored at a local database node, even if the data is stored at a distant database node. Therefore the method minimizes the impact of the geographical separation of the database nodes whilst maintaining the advantages provided by a distributed architecture.

The first database node may forward the request to the second database node and substantially simultaneously sends the early response to the client. As such, the first database node may send the early response to the client either immediately prior to, at the same time as or immediately after forwarding the request to the second database node.

If the data is stored or is intended to be stored at a second database node, an early response may only sent if it is determined that an early response should be sent to the client. This can be determined in dependence upon any of:
an identity of the client that sent the data manipulation request; and
the contents or type of data manipulation request.

It may be determined that an early response should not be sent to the client if the request includes an indicator that an early response should not be sent. Similarly, it may be determined that an early response should be sent to the client if the request includes an indicator that an early response is allowed or required. In addition, an early response may include an indicator indicating that it is an early response.

If an early response is sent to the client, the final response may be forwarded to the client once it is received from the second database node. The final response may only be forwarded to the client if the request includes an indicator indicating that a final response is required. Similarly, the final response may not be forwarded to the client if the request includes an indicator indicating that a final response is not required.

If the data is stored or is intended to be stored at the first database node, then the method will preferably further comprise, performing the data manipulation at the first database node and then sending a final response to the client indicating whether or not the data manipulation has been successful.

A request to manipulate data may comprise any of:
a request to modify data;
a request to move data;
a request to add or store data; and
a request to delete data.

According to a second aspect of the present invention these is provided an apparatus configured to operate as a database node of a distributed database, said distributed database comprising a plurality of database nodes. The apparatus comprises:
a receiver for receiving a request to manipulate data;
a data locator for determining if the data is stored or is intended to be stored at the database node;
a transmitter for forwarding the request towards a second database node of the plurality of database nodes, if the data is not stored or is not intended to be stored at the database node;
a processor for generating an early response to the data manipulation request indicating that the data manipulation has been successful;
a transmitter for sending the early response to the client; and
a receiver for receiving a final response from the second database node;
wherein the processor is configured to instruct the transmitter to send the early response to the client prior to receiving the final response from the second database node.

The processor may be configured to instruct the transmitter to send the early response to the client and to forward the request to the second database node substantially simultaneously. As such, the processor may be configured to instruct the transmitter to send the early response either immediately prior to, at the same time as or immediately after the request is forwarded to the second database node.

The processor may be configured to only generate an early response if it determines that an early response should be sent to the client. This determination may be made in dependence upon any of:
an identity of the client that sent the data manipulation request; and
the contents or type of data manipulation request.

The processor may be configured to determine that an early response should not be sent to the client if the request includes an indicator that an early response should not be sent. Similarly, the processor may be configured to determine that an early response should be sent to the client if the request includes an indicator that an early response is allowed or required. The processor may be configured to include, within an early response, an indicator indicating that it is an early response.

The processor may be configured to instruct the transmitter to forward the final response received from the second database node to the client once it is received. However, the processor may be configured to only instruct the transmitter to forward the final response to the client if the request includes an indicator indicating that a final response is required. The processor may be configured not to instruct the transmitter to forward the final response to the client if the request includes an indicator indicating that a final response is not required.

The processor may be further configured to perform the data manipulation and to generate a final response for sending to the client indicating whether or not the data manipulation has been successful, if the data is stored or is intended to be stored at the database node.

According to a third aspect of the present invention there is provided a method of operating a client of a distributed database. The method comprises, at the client:
generating a request to manipulate data, the request including an indicator that an early response is allowed or required;
sending the request to a first database node of a plurality of database nodes that comprise the distributed database; and
receiving a response from the first database node;
wherein an early response is a response sent by the first database node prior to receiving a final response from a second database node that stores or is intended to store the data that requires manipulation.

The method may further comprise a step of determining if the response received from the first database node is an early response or a final response. The response received from the first database node may be determined to be an early response if the response includes an indicator indicating that the response is an early response. The response received from the first database node may be determined to be a final response if the response received does not includes an indicator indicating that the response is an early response.

The method may further comprise a step of including in the request an indicator that a final response is also required.

According to a fourth aspect of the present invention there is provided an apparatus configured to operate as a client of a distributed database. The apparatus comprises:
a processor for generating a request to manipulate data, the request including an indicator that an early response is allowed or required;
a transmitter for sending the request to a first database node of a plurality of database nodes that comprise the distributed database; and
a receiver for receiving a response from the first database node;
wherein an early response is a response sent by the first database node prior to receiving a final response from a second database node that stores or is intended to store the data that requires manipulation.

The processor may be further configured to determine if the response received from the first database node is an early response or a final response. The processor may be configured to determine that the response is an early response if the response received from the first database node includes an indicator indicating that the response is an early response. The processor may be further configured to determine that the response is a final response if the response received from the first database node does not include an indicator indicating that the response is an early response.

The processor may be further configured to include, in the request, an indicator that a final response is also required.

### BRIEF DESCRIPTION OF THE DRAWINGS

Some embodiments of the present invention will now be described in detail with reference to the accompanying drawings, in which:

FIG. 1 illustrates schematically an example of a distributed database system;

FIG. 2 is an example signalling flow diagram of a client accessing data stored in a remote database node of a distributed database;

FIG. 3 is an example signalling flow diagram of a client requesting manipulation of data stored at a remote database node of a distributed database;

FIG. 4A is an example signalling flow diagram illustrating a first database node sending an early response immediately before forwarding a request to a second database node;

FIG. 4B is an example signalling flow diagram illustrating a first database node sending an early response immediately after forwarding a request to a second database node;

FIG. 4C is an example signalling flow diagram illustrating a first database node sending an early response at the same time as forwarding a request to a second database node;

FIG. 5 is an example signalling flow diagram illustrating a first database node sending an early response to a client and forwarding on a final response;

FIG. 6 illustrates schematically an embodiment of an optimised distributed database system;

FIG. 7 is a flow diagram illustrating an example of a process implemented by a database client; and

FIG. 8 is a flow diagram illustrating an example of a process implemented by a database node of a distributed database.

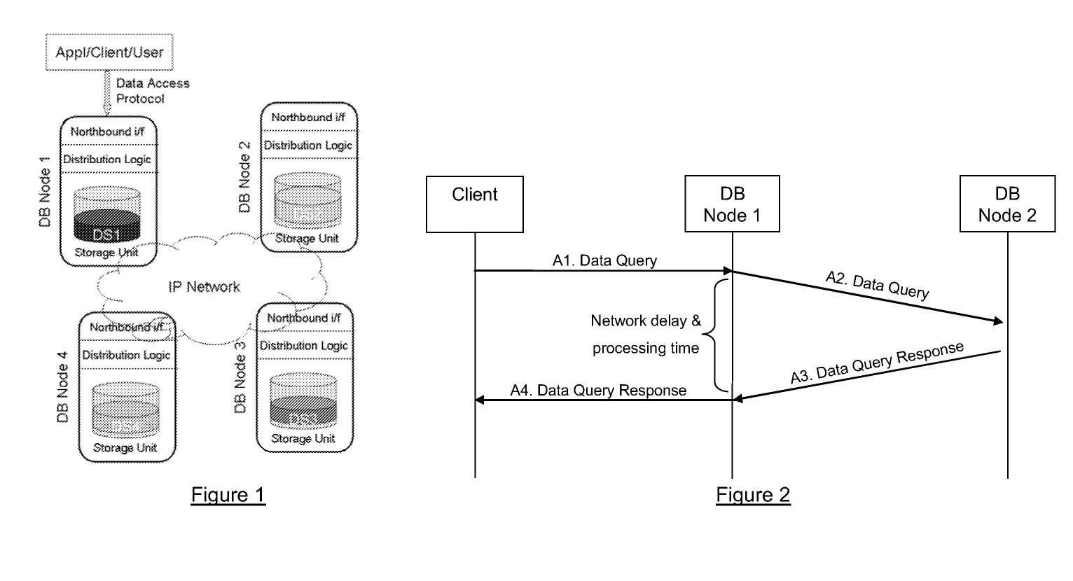

### DETAILED DESCRIPTION OF CERTAIN EMBODIMENTS

There will now be described a method of operating a distributed database that minimizes the impact of the geographical separation of the database nodes whilst maintaining the advantages provided by a distributed architecture. The method involves database nodes that, upon receiving a request from a client to manipulate data that is stored or is intended to be stored at another of the database nodes, forward the request towards the database node that stores or is intended to store the data and send an early response to the client indicating that the data manipulation has been successful, the early response being sent prior to receiving a final response from the database node storing the data.

The early response is therefore sent before the database node that stores or is intended to store the data has indicated that the requested data manipulation has actually been successfully completed. However, it is assumed that a distributed database system will successfully complete a large majority of the data manipulation requests, such that an early response that optimistically indicates that the request has been successfully fulfilled will most often be accurate. In sending a response to the client in advance of the receipt of a final response from the database node that stores or is intended to store the data, this method provides that the latency experienced by the client can be minimised, even on those occasions when the data is not stored locally at the database node providing the clients point of contact, by reducing/eliminating the impact of the geographical distance between the database nodes.

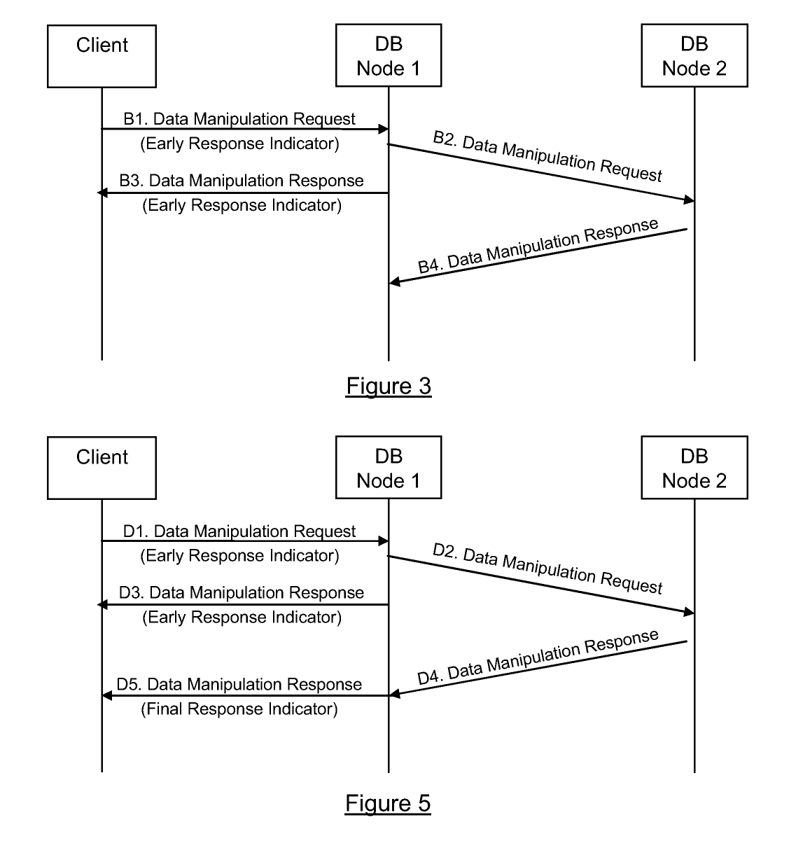

FIG. 3 is an example signalling flow diagram of a client requesting manipulation of data stored at a remote database node of a distributed database. The steps performed are as follows:
B1. A client sends a data manipulation request relating to some data to the distributed database. To do so, the client is configured with the identity/address of a first database node that is to act as a point of contact for the client. In this example, the client sends the request to its local database node, DB Node 1.
B2. The distribution logic of DB Node 1 processes the query to determine whether or not it stores or is intended to store the data that is the subject of the query. In this example, DB Node 1 determines that it does not store the data, and that this data is stored at a second database node, DB Node 2. DB Node 1 therefore forwards the request towards DB Node 2.
B3. DB Node 1 also determines whether or not it should send an optimistic early response to the client. The determination can be accomplished according to various embodiments that shall be later described. In the illustrated example, the client has included a flag in the request received by DB Node 1, indicating that an early response is required or allowed. DB Node 1 therefore sends an early response to the client indicating the data manipulation request has been successfully completed. The response may take the same form as a normal, final response. Alternatively, the response could include a flag indicating that this is an early response.
B4. The distribution logic of DB Node 2 processes the request and determines that the data is stored in the storage unit of DB Node 2. DB Node 2 therefore attempts to perform the requested data manipulation, generates a response to the request indicating the result, and sends the response back to DB Node 1.

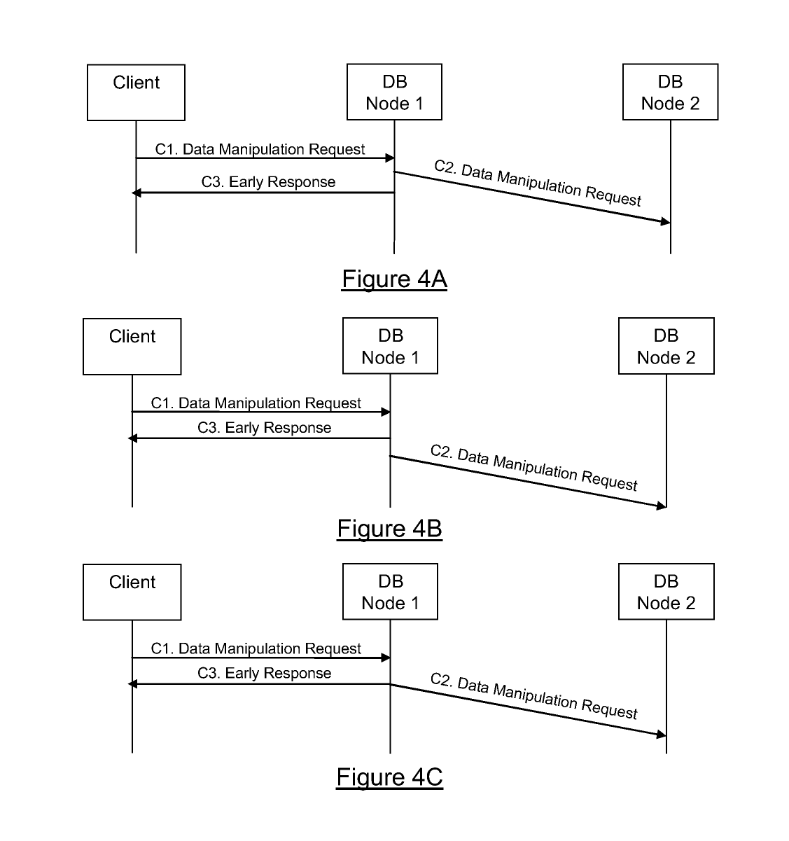

In order to minimise the delay, the first database node forwards the request to the second database node and substantially simultaneously sends the early response to the client. This may involve sending the early response to the client either immediately prior to, at the same time as or immediately after forwarding the request to the second database node. FIGS. 4A, 4B and 4C are example signalling flow diagrams illustrating a first database node sending the early response immediately before (FIG. 4A), immediately after (FIG. 4B), and at the same time as forwarding the request to a second database node (FIG. 4C).

The first database node, that receives the data manipulation request from the client, can be configured to send an early response to all data manipulation requests for which the data is stored or is intended to be stored at a second, remote database node. Alternatively, the first database node can be configured to determine whether or not to send an early response based on the type and/or identity of the client that sent the data manipulation request. For example, the database nodes could be configured with a list of client identities or client types that require or allow early responses. As a further alternative, the database nodes could be configured to determine whether or not to send an early response based on the type of data manipulation request and/or the type of data referred to in the request. For example, database nodes could be configured to allow early response for “LDAP Modify” requests, but to not allow early response for “LDAP Modify DN” requests. By way of further example, the database nodes could be configured with a list identifying types of data that do not allow an early response.

The client of the distributed database may also be configured to include a flag within a data manipulation requests. This flag can indicate explicitly whether they require or allow an early response to be sent for this particular request. Alternatively, the flag could indicate that an early response is not allowed, or should not be sent for the request. The database nodes would then be configured to respond accordingly. The database nodes may also be configured to determine whether or not an early response can be sent based on a combination of any of the above factors.

If required, the database nodes can also be configured to send the final response on to the client once it is received. FIG. 5 is an example signalling flow diagram illustrating a first database node sending an early response to a client and also forwarding on the final response. The steps performed are as follows:
D1. A client sends a data manipulation request relating to some data to its local database node, DB Node 1.
D2. The distribution logic of DB Node 1 processes the query to determine whether or not it stores or is intended to store the data. In this example, DB Node 1 determines that it does not store the data and that this data is stored at a second database node, DB Node 2. DB Node 1 therefore forwards the request towards DB Node 2.
D3. DB Node 1 also determines that it should send an optimistic early response to the client and therefore sends an early response to the client indicating the data manipulation request has been successfully completed.
D4. DB Node 2 attempts to perform the requested data manipulation, generates a response to the request indicating the actual result of the data manipulation, and sends the response back to DB Node 1.
D5. DB Node 1 receives the response from DB Node 2. DB Node 1 then determines whether or not it should also send the final response to the client. For example, the client can include a flag in the request, indicating that the final response should be forwarded on. In this example, DB Node 1 forwards the final response to the client, the final response indicating whether or not the data manipulation request has been successfully completed. The final response can include a flag indicating that this is a final response.

The first database node, that receives the data manipulation request directly from the client, can be configured to forward the final response to the client for all data manipulation requests for which an early response has been sent. Alternatively, the first database node can be configured to determine whether or not to send a final response to the client based on the type and/or identity of the client that sent the data manipulation request. For example, the database nodes could be configured with a list of client identities or client types that require or allow final responses. As a further alternative, the first database node could be configured to determine whether or not to send a final response to the client based on the type of data manipulation request and/or the type of data referred to in the request. By way of further example, the database nodes could be configured with a list identifying types of data that do not allow a final response to be sent. As a yet further alternative, the database nodes can be configured to only forward the final response if it indicates that the data manipulation has not been successfully completed.

The clients of such a distributed database may also be configured to include a flag within a data manipulation request that indicates whether they require the final response to be sent for this particular request. Alternatively, the flag could indicate that the final response should not be sent for the request. The database nodes would then be configured to respond accordingly. The database nodes may also be configured to determine whether or not to forward on the final response based on a combination of any of the above factors.

In addition, flags indicating whether or not early response and/or final responses should be sent could be used to set this behaviour for the duration of a communication session initiated between a client and a distributed database. To do so, the flags could be included in the database access protocol message that establishes the session with the clients local database node. For example, such flags could be included in a Lightweight Directory Access Protocol (LDAP) Bind message sent to the distributed database.

If the data that is the subject of the data manipulation request is stored or is intended to be stored locally, then the local database node will operate as normal, by attempting to perform the requested data manipulation and then, upon execution success or failure, sending a response to the client indicating whether or not the requested manipulation has been successful.

By employing this method, a client would receive responses to data manipulation requests with a latency substantially equal to that experienced for data that is stored or that is intended to be stored at a local database node, even if the data is stored at a distant database node. As such, if the above method was applied to all data manipulation requests, the average time for receiving a response would be equal to the local latency. Considering the above example, the average latency would then be 7 ms as opposed to 17.5 ms. Taking into account that most systems will have a very low likelihood of errors, this method would provide improved latency without introducing a significant degradation in performance. However, such distributed database systems should be configured so as to be able to handle any errors that do occur, wherein a data manipulation request is not successfully completed. In these circumstances, the distributed database could be configured to send the final response to the client such that the client can determine whether a further request is necessary. Alternatively, the first database node could be configured to replicate the request in the hope that further attempts will succeed.

This method could be implemented for any database technology through the introduction of the necessary extensions/modifications of the associated access protocol, such as the Lightweight Directory Access Protocol (LDAP), Structured Query Language (SQL), Simple Object Access Protocol (SOAP) etc. For example, LDAP (see IETF RFC 2251) provides “controls” as a mechanism for extending an LDAP operation. A control is a way to specify additional information that is to be included as part of a request and a response. One or more controls may be attached to a single LDAP message.

In order to implement the method described above two new LDAP controls could be defined, the “early response flag” and the “final response flag”. The presence of an “early response flag” in a request issued by a database client could imply that the database client explicitly requests that an early response be sent by the database node that first receives the request, if the data that is the subject of the request is not stored or is not intended to be stored at that database node. The presence of the “early response flag” in a response sent by a database node to a database client implies that the response is an early response sent by said the database node. The presence of a “final response flag” in a request issued by a database client indicates whether or not the client wants to receive the response indicating the actual outcome of the requested data manipulation, which would then be the second (final) response received by the database client (i.e. if the client included an “early response flag” in the corresponding request). The “criticality” field associated with these controls could be set to FALSE, such that a database node that did not support the control or that determined that the control was inappropriate would ignore the control and perform the operation as if the control(s) was not received. These controls would then simply be attached to the existing data manipulation request and response messages supported by LDAP.

These controls could be attached to any of the following LDAP messages, which are examples of data manipulation requests, and of the corresponding responses:
an LDAP Modify Request;
an LDAP Modify Response;
an LDAP Add Request;
an LDAP Add Response;
an LDAP Delete Request;
an LDAP Delete Response;
an LDAP Modify DN Request; and
an LDAP Modify DN Response.

Alternatively, if a client/application wised to set the response behaviour for the duration of a session, then the flag controls could be included into an LDAP Bind Request.

An example of an application that can make use of distributed database is a Home Location Register (HLR) of a GSM core network. In some network architectures, a HLR is a Front End server that accesses data stored in a distributed user database. However, a HLR requires high throughput with very low latency and would therefore benefit from employing the method outlined above.

In this example, if an error was to occur, wherein an early response was sent to the HLR indicating that a requested data manipulation was successful with the actual attempt to manipulate data being unsuccessful, then this may to lead to some temporary failures. For example, if an attempt to update a subscriber's Visitor Location Register (VLR) Number is not successful, then the network would temporarily be unable to locate the subscribe. However, this problem would be solved as soon as the next Update Location message is received. Therefore, when requesting manipulation of such data, the HLR could request an early response and indicate that the final response is not required, as it would be unnecessary for the HLR to take any action if an error was to occur. By way of further example, if the HLR wanted to update some data that prohibits a subscriber from accessing a service (i.e. barring), then the HLR will preferably indicate that an early response should not be sent (e.g. by not including the appropriate flag), as a failure to successfully update such data in the user database could allow a subscriber to access the barred service.

In addition, the 3rd Generation Partnership Project (3GPP) is standardizing the User Data Convergence (UDC) concept (see 3GPP TS 23.335 and TS 29.335), in which the Core Network consolidates data into a centralized User Data Repository (UDR). This centralized data repository can be implemented by means of a distributed database. However, the UDR is required to store a huge amount of data with a very high throughput and very low latencies. As such, the implementation of the above-described method would be highly beneficial in such a distributed database system.

The concepts described above can be applied to any distributed database system, regardless of the particular storage technology used (e.g. whether on disks and/or solid state memory chips), the particular data distribution employed (e.g. whether or not data replication is implemented), and data access protocol used. They also provide that the latency perceived by the database clients when requesting manipulation of any data is significantly reduced. This in-turn decreases the resource usage at the database clients when accessing the database. The concepts described above therefore also provide that latency perceived by the database clients does not increase as the distances between the database nodes is increased, therefore removing or at least reducing the limitations on these distances. In addition, these mechanisms are flexible such that they can be selectively implemented as and when they are desired or required. Furthermore, this also provides that not all clients/applications accessing a distributed database that is provided with the above-described functionality need be capable of implementing these mechanisms, but can continue to make use of the distributed database using the standard request and response functions.

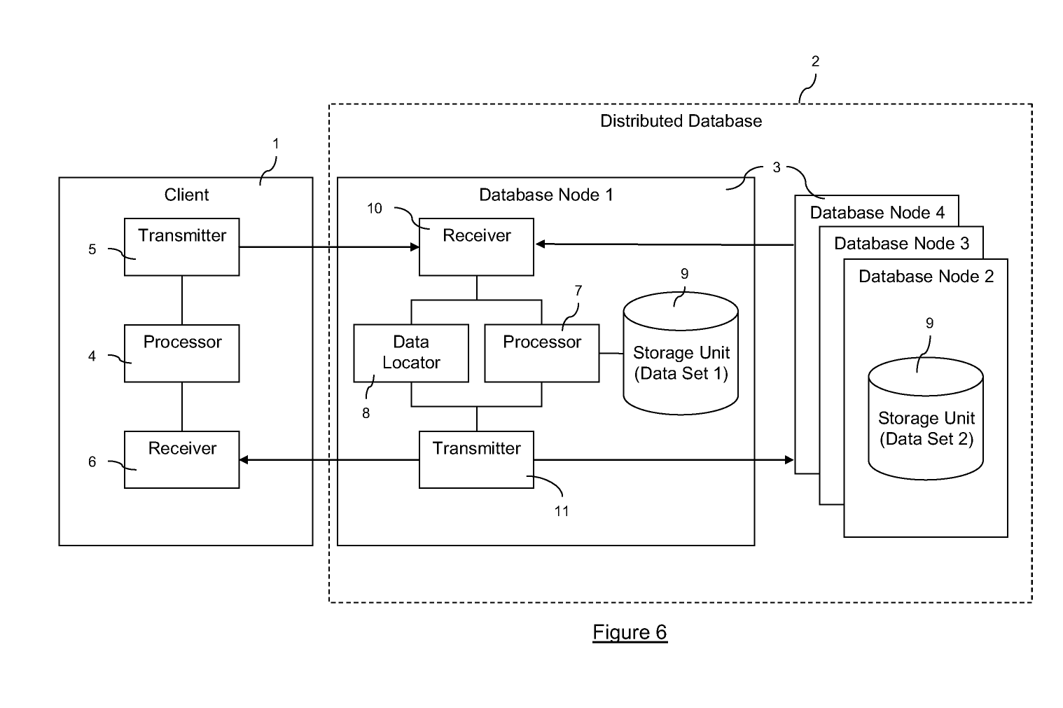

FIG. 6 illustrates schematically an embodiment of a distributed database system configured to perform the methods described above. The distributed database system comprises at least one database client 1 and a distributed database 2. The distributed database 2 is further comprised of a plurality of database nodes 3 (e.g. DB Nodes 1, 2, 3 and 4). Each database client is comprised of a processor 4, a transmitter 5 and a receiver 6. Each of the database nodes is comprised of a processor 7, a data locator/distribution logic 8, a storage unit 9, a receiver 10 and a transmitter 11. Each database client 1 communicates with its local, point of contact database node over an interface using its transmitter 5 and receiver 6. The database nodes communicate with their associated clients and with the remote database nodes using their receivers 10 and transmitters 11.

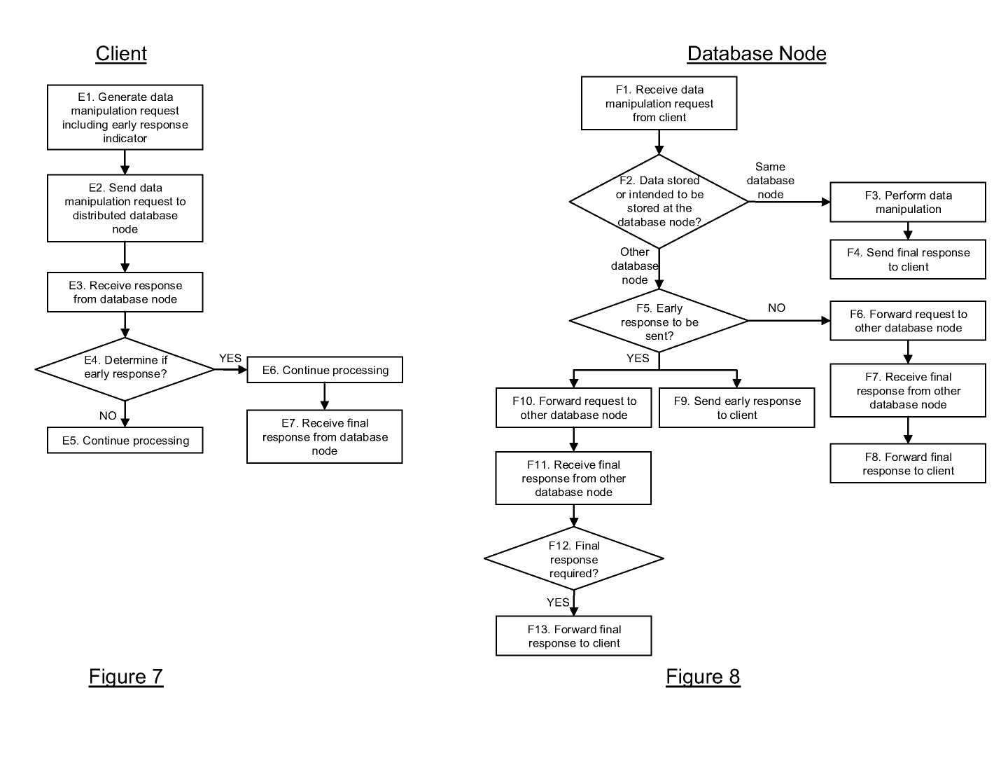

FIG. 7 is a flow diagram illustrating an example of the process implemented by a database client when requesting manipulation of data stored in a distributed database. The steps performed are as follows:
E1. The client's processor 4 generates a data manipulation request including an indicator that indicates, to its local point of contact database node, that it requires or allows an early response to be sent.
E2. The data manipulation request is then sent to the client's point of contact database node by the transmitter 5.
E3. The client then receives a data manipulation response from its local database node using the receiver 6.
E4. The processor 4 can process the response as if it were a standard, final response, or, as illustrated in this example, it can determine if the response is an early response. For example, the processor 4 can check the response to determine if the response includes an indicator indicating that it is an early response.
E5. If the processor 4 determines that the response is not an early response, then the processor continues processing the message as required. For example, as the processor has determined that the message is not an early response, the processor will process the message as a final response to determine if the data manipulation has been successful and take any appropriate action.
E6. If the processor 4 determines that the response is an early response, it will consider the data manipulation complete and continue with any subsequent actions. An early response will only be received if the data that was the subject of the data manipulation request is stored or is intended to be stored at a remote database node (i.e. a database node other than that to which the client first sent the data manipulation request).
E7. If a final response has been requested, or the local database node has determined that a final response should be sent, then at some point later the client will receive a final response from the local database node. The final response will have been forwarded from a remote database node that stored the data that was the subject of the data manipulation request.

FIG. 8 is a flow diagram illustrating an example of the process implemented by a database node of a distributed database when processing a request for manipulation of data. The steps performed are as follows:
F1. The database node receives a data manipulation request from one of its local clients using receiver 10.
F2. The data locator/distribution logic 8 then determines whether or not the data that is a subject of the request is stored or is intended to be stored at the database node (i.e. whether the data is stored locally or at a remote database node). If the data is stored or should be stored locally, then the process proceeds to step F3. If not, then the process proceeds to step F5.
F3. If the data locator 8 determines that the data is stored or should be stored locally, then the request is passed to the processor 7 which attempts to perform the requested data manipulation on the data stored in the storage unit 9.
F4. The processor 7 then generates a data manipulation response indicating the result of the attempted data manipulation. The processor 7 may also include an indicator in the response, indicating that the response is a final response.
F5. If the data locator 8 determines that the data is stored or is intended to be stored at a remote database node, then the request is passed to the processor 7 which determines whether an early response should be sent. For example, the request may include a flag indicating that an early response is required, or the database node may be configured to send an early response for all requests of this type, etc. If an early response is not to be sent, then the process proceeds to step F6. If an early response is to be sent, then the process proceeds to steps F9 and F10.
F6. If the processor 7 determines that an early response should not be sent, then the request is forwarded towards the remote database node that stores the data using the transmitter 11. For example, if the distribution logic 8 has been able to identify exactly which of the other database nodes stores the data, then the processor will ensure that the request is forwarded to the identified database node. Alternatively, the distribution logic 8 may be able to identify one of the other database nodes to which the request should be forwarded in order to finally reach the database node storing the data (i.e. the a next closest database node). The processor will ensure that the request is forwarded to this next database node, which should be ‘closer’ to the database node storing the data.
F7. The database node then receives a final response from the remote database node using the receiver 10.
F8. The database node then forwards the final response on to the client using the transmitter 11. The database node may modify the final response so as to include an indicator indicating the response is final response, in order to indicate to the client that this a final response.
F9. If the processor 7 determines that an early response should be sent, then the processor generates an early response indicating that the data manipulation has been successful and sends this to the client using transmitter 11.
F10. The processor 7 also ensures that the request is forwarded towards the remote database node immediately prior to, at the same time as, or immediately after the early response is sent to the client. The request is forwarded using the transmitter 11.
F11. The database node receives a final response from the remote database node that stores the data using the receiver 10. The final response indicates the actual result of the attempted data manipulation.
F12. The processor 7 then determines if the final response should be sent to the client. For example, it determines whether or not the request included a flag indicating that a final response is required, or it determines if a final response should be sent for all requests of this type etc. If the processor determines that a final response should not be sent, then the process ends.
F13. If the processor determines that a final response should be sent, then the response is forwarded to the client using transmitter 11.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, a node of a distributed database may act only as a ‘front-end’ that provides database access to database clients whilst not itself storing any data. In this case, all data manipulation requests will be forwarded by the “front end” database node to other database nodes that store data, and the local, front-end database node should determine whether or not to send early responses in the same way as the above-described embodiments.

1. A method of operating a distributed database comprising a plurality of database nodes, the method comprising:
at a first database node of the plurality of database nodes:
receiving, from a client, a request to manipulate data;
determining if the data is stored or is intended to be stored at the first database node; and
if the data is not stored or is not intended to be stored at the first database node:
forwarding the request towards a second database node of the plurality of database nodes; and,
prior to receiving a response from the second database node indicating a result of the data manipulation, herein referred as “final response”, sending a response to the client indicating that the data manipulation has been successfully completed, herein referred as “early response”.

2. The method of claim 1, further comprising the first database node forwarding the request to the second database node and substantially simultaneously sending the early response to the client.

3. The method of claim 2, further comprising the first database node sending the early response to the client either immediately prior to, at the same time as, or immediately after forwarding the request to the second database node.

4. The method of claim 1, further comprising, if the data is stored or is intended to be stored at a second database node, sending an early response only if it is determined that an early response should be sent to the client.

5. The method of claim 4, further comprising determining whether or not an early response should be sent to client in dependence upon any of:
an identity of the client that sent the data manipulation request; and
the contents or type of data manipulation request.

6. The method of claim 4, further comprising determining that an early response should not be sent to the client if the request includes an indicator that an early response should not be sent.

7. The method of claim 4, further comprising determining that an early response should be sent to the client if the request includes an indicator that an early response is allowed or required.

8. The method of claim 1, further comprising including in the early response an indicator indicating that it is an early response.

9. The method of claim 1, and further comprising:
if an early response is sent to the client, forwarding the final response to the client once it is received from the second database node.

10. The method of claim 9, further comprising forwarding the final response to the client only if the request includes an indicator indicating that a final response is required.

11. The method of claim 9, further comprising not forwarding the final response to the client if the request includes an indicator indicating that a final response is not required.

12. The method of claim 1, further comprising:
if the data is stored or is intended to be stored at the first database node, performing the data manipulation at the first database node and then sending a final response to the client indicating whether or not the data manipulation has been successful.

13. The method of claim 1, wherein a request to manipulate data comprises any of:
a request to modify data;
a request to move data;
a request to add or store data; and
a request to delete data.

14. An apparatus configured to operate as a database node of a distributed database, said distributed database comprising a plurality of database nodes, the apparatus comprising:
a receiver configured to receive a request to manipulate data;
a data locator configured to determine if the data is stored or is intended to be stored at the database node;
a transmitter fief-configured to forward the request towards a second database node of the plurality of database nodes, if the data is not stored or is not intended to be stored at the database node;
a processor configured to generate a response, herein referred as “early response”, to the data manipulation request indicating that the data manipulation has been successfully completed;
a transmitter configured to send the early response to the client; and
a receiver configured to receive a response from the second database node indicating a result of the data manipulation, herein referred as “final response”;
wherein the processor is further configured to instruct the transmitter to send the early response to the client prior to receiving the final response from the second database node.

15. An apparatus as claimed in claim 14, wherein the processor is configured to instruct the transmitter to send the early response to the client and to forward the request to the second database node substantially simultaneously.

16. An apparatus as claimed in claim 15, wherein the processor is configured to instruct the transmitter to send the early response either immediately prior to, at the same time as or immediately after the request is forwarded to the second database node.

17. An apparatus as claimed in claim 14, wherein the processor is configured to generate the early response only if the processor determines that an early response should be sent to the client.

18. An apparatus as claimed in claim 17, wherein the processor is configured to determine whether or not an early response should be sent to client in dependence upon any of:
an identity of the client that sent the data manipulation request; and
the contents or type of data manipulation request.

19. An apparatus as claimed in claim 17, wherein the processor is configured to determine that an early response should not be sent to the client if the request includes an indicator that an early response should not be sent.

20. An apparatus as claimed in claim 17, wherein the processor is configured to determine that an early response should be sent to the client if the request includes an indicator that an early response is allowed or required.

21. An apparatus as claimed in claim 14, wherein the processor is configured to include, within an early response, an indicator indicating that it is an early response.

22. An apparatus as claimed in claim 14, wherein the processor is configured to instruct the transmitter to forward the final response received from the second database node to the client once it is received.

23. An apparatus as claimed claim 22, wherein the processor is configured to only instruct the transmitter to forward the final response to the client if the request includes an indicator indicating that a final response is required.

24. An apparatus as claimed claim 22, wherein the processor is configured not to instruct the transmitter to forward the final response to the client if the request includes an indicator indicating that a final response is not required.

25. An apparatus as claimed in claim 14, wherein the processor is further configured to perform the data manipulation and to generate a final response for sending to the client indicating whether or not the data manipulation has been successful, if the data is stored or is intended to be stored at the database node.

26. A method of operating a client of a distributed database, the method comprising at the client:
generating a request to manipulate data, the request including an indicator that an early response is allowed or required;
sending the request to a first database node of a plurality of database nodes that comprise the distributed database; and
receiving a response from the first database node;
wherein an early response is a response sent by the first database node to the client indicating that the data manipulation request has been successfully completed, prior to receiving by the first database node of a response indicating a result of the data manipulation from a second database node that stores or is intended to store the data that requires manipulation, herein referred as “final response”.

27. The method of claim 26, further comprising:
determining if the response received from the first database node is an early response or a final response.

28. The method of claim 27, further comprising determining whether the response received from the first database node is an early response if the response includes an indicator indicating that the response is an early response.

29. The method of claim 27, further comprising determining whether the response received from the first database node is a final response if the response received does not includes an indicator indicating that the response is an early response.

30. The method of claim 26, further comprising:
including in the request an indicator that a final response is also required.

31. An apparatus configured to operate as a client of a distributed database, the apparatus comprising:
a processor configured to generate a request to manipulate data, the request including an indicator that an early response is allowed or required;
a transmitter configured to send the request to a first database node of a plurality of database nodes that comprise the distributed database; and
a receiver configured to receive a response from the first database node;
wherein an early response is a response sent by the first database node to the client indicating that the data manipulation request has been successfully completed, prior to receiving by the first database node of a response indicating a result of the data manipulation from a second database node that stores or is intended to store the data that requires manipulation, herein referred as “final response”.

32. An apparatus as claimed in claim 31, wherein the processor is further configured to determine if the response received from the first database node is an early response or a final response.

33. An apparatus as claimed in claim 32, wherein the processor is configured to determine that the response is an early response if the response received from the first database node includes an indicator indicating that the response is an early response.

34. An apparatus as claimed in claim 32, wherein the processor is further configured to determine that the response is a final response if the response received from the first database node does not include an indicator indicating that the response is an early response.

35. An apparatus as claimed in claim 31, wherein the processor is further configured to include, in the request, an indicator that a final response is also required.
